(19) United States
(12) Patent Application Publication
(10) Pub. No.: US 2021/0039357 A1
(43) Pub. Date: Feb. 11, 2021

(54) VEHICLE WINDSHIELD

(71) Applicant: AGC Inc., Tokyo (JP)

(72) Inventors: Ryota NAKAMURA, Tokyo (JP); Tokihiko AOKI, Tokyo (JP)

(73) Assignee: AGC Inc., Tokyo (JP)

(21) Appl. No.: 17/067,037

(22) Filed: Oct. 9, 2020

Related U.S. Application Data
(63) Continuation of application No. PCT/JP2019/015916, filed on Apr. 12, 2019.

(30) Foreign Application Priority Data
Apr. 19, 2018 (JP) 2018-080601

(51) Int. Cl. B32B 17/10; B60J 1/00

(52) U.S. Cl. CPC B32B 17/10009; B60J 1/00

(57) ABSTRACT

The present invention relates to a vehicle windshield including a laminated glass in which a first glass plate, a first adhesive layer, an infrared reflective film, a second adhesive layer, and a second glass plate are laminated in this order, wherein a total thickness of the first glass plate and the second glass plate is 4.1 mm or less, the infrared reflective film contains a laminate in which 100 or more resin layers having different refractive indexes are laminated, the infrared reflective film has thermal contraction rates, wherein a thermal contraction rate in the direction which the thermal contraction rate being maximum is 1.5% or more and 2.0% or less, and a thermal contraction rate in the direction orthogonal to the aforementioned direction is 1.5% or more and 2.0% or less.

### CROSS-REFERENCE TO RELATED APPLICATIONS

This U.S. non-provisional application is a continuation application of and claims the benefit of priority under 35 U.S.C. § 365(c) from PCT International Application PCT/JP2019/015916 filed on Apr. 12, 2019, which is designated the U.S., and is based upon and claims the benefit of priority of Japanese Patent Application No. 2018-080601 filed on Apr. 19 2018, the entire contents of which are incorporated herein by reference.

### TECHNICAL FIELD

The present invention relates to a vehicle windshield, and more particularly to a vehicle windshield formed of a laminated glass using an infrared reflective film.

### BACKGROUND OF THE INVENTION

Conventionally, as a laminated glass used for a vehicle windshield, a laminated glass in which an infrared reflective film is sandwiched between a pair of glass plates via an adhesive layer is known. A laminated glass is produced, for example, by stacking a glass plate, an adhesive layer, an infrared reflective film, an adhesive layer, and a glass plate in this order. Then, the entire laminated glass is heated and pressed to integrate them. In the production of such laminated glass, unevenness due to pressure because of uneven thickness of adhesive layers, warp or wrinkles of films due to the difference in the thermal contraction rate between the films and the adhesive layers are generated in the film, resulting in impairing the appearance of the laminated glass. Accordingly, the solution to solve this problem has been considered.

For example, Patent Document 1 discloses the technique of a multilayer laminated film which defines thermal contraction stress of a film so as to suppress unevenness in an appearance of the film in the multilayer laminated film having a function of interfering and reflecting infrared rays by alternately laminating resin layers having different refractive indexes.

Further, Patent Document 2 discloses a laminated glass in which any one of a thermal contraction rate, an elastic modulus, and an elongation of the infrared reflective film is controlled so as to fall within a predetermined range in order to suppress wrinkles of the film, which are particularly likely generated at the edge of the film in the case of using a glass plate curved by bending.

On the other hand, it is known that a phenomenon in which the contour of a reflected image appears to fluctuate, so-called orange peel, is generated in a laminated glass using an infrared reflective film. Generation of orange peel on vehicle windshields is not preferable from the viewpoint of appearance and visibility from vehicle interior-side. The cause of orange peel is considered to be the waviness of the infrared reflective film itself generated during the production of laminated glass, or the waviness of the film surface due to the infrared reflective film being pulled toward the center due to the contraction of the adjacent adhesive layer.

As described above, Patent Document 1 and Patent Document 2 disclose suppressing of deterioration of the appearance of the laminated glass such as unevenness and wrinkles due to the infrared reflective film. However, these conventional techniques do not consider to improve other characteristics demanded for windshields for vehicles while suppressing the generation of orange peel.

### RELATED-ART DOCUMENT

### Patent Documents

Patent document 1: International Patent Publication No. 2013/137288

Patent document 2: Japanese Unexamined Patent Publication No. 2010-180089

### SUMMARY OF THE INVENTION

### Problems to be Solved by the Invention

The present invention provides a vehicle windshield containing a laminated glass using an infrared reflective film, which has excellent heat shield properties and a good appearance. In particular, the vehicle windshield of the present invention is capable of suppressing the generation of a phenomenon in which the contour of the reflected image appears to fluctuate (hereinafter, also referred to as “orange peel”).

### Means for Solving the Problems

A vehicle windshield includes a laminated glass in which a first glass plate, a first adhesive layer, an infrared reflective film, a second adhesive layer, and a second glass plate are laminated in this order, wherein a total thickness of the first glass plate and the second glass plate is 4.1 mm or less, the infrared reflective film contains a laminate in which 100 or more resin layers having different refractive indexes are laminated, the infrared reflective film has thermal contraction rates, wherein a thermal contraction rate in the direction which the thermal contraction rate being maximum is 1.5% or more and 2.0% or less, and a thermal contraction rate in the direction orthogonal to the aforementioned direction is 1.5% or more and 2.0% or less, and the thermal contraction rates of the infrared reflective film in the predetermined directions being reduction rates of lengths in the predetermined directions before versus after maintaining the infrared reflective film at 150° C. for 30 minutes, and a thickness of the infrared reflective film is 80 μm or more and 120 μm or less.

### Effect of the Invention

According to the present invention, the present invention provides a vehicle windshield containing a laminated glass using an infrared reflective film, which has excellent heat shield properties and a good appearance. In particular, the vehicle windshield of the present invention is capable of suppressing the generation of a phenomenon in which the contour of the reflected image appears to fluctuate (hereinafter, also referred to as “orange peel”).

### BRIEF DESCRIPTION OF THE DRAWINGS

FIG. 1 is an example of the front view of the laminated glass which forms the vehicle windshield in an embodiment of this invention.

FIG. 2 is a cross-sectional view taken along the line X-X of the laminated glass shown in FIG. 1.

FIG. 3 is a figure explaining the method of evaluating the distortion of the transmitted image in Examples.

FIG. 4 is another figure for explaining the method of evaluating the distortion of the transmitted image in Examples.

FIG. 5 is still another figure for explaining the method of evaluating the distortion of the transmitted image in Examples.

### DETAILED DESCRIPTION

Embodiments of the present invention will be described below. The present invention is not limited to these embodiments, and these embodiments can be changed or modified without departing from the spirit and scope of the present invention.

The vehicle windshield of the present embodiment (hereinafter, simply referred to as “windshield”) includes a laminated glass in which a first glass plate, a first adhesive layer, an infrared reflective film, a second adhesive layer, and a second glass plate are laminated in this order, wherein the total thickness of the first glass plate and the second glass plate is 4.1 mm or less, and the infrared reflective film has the following requirements of (1) to (3).

(1) The infrared reflective film includes a laminate in which 100 or more resin layers having different refractive indexes are laminated.
(2) The infrared reflective film has thermal contraction rates, wherein a thermal contraction rate in the direction which the thermal contraction rate being maximum is 1.5% or more and 2.0% or less, and a thermal contraction rate in the direction orthogonal to the aforementioned direction is 1.5% or more and 2.0% or less, and the thermal contraction rates of the infrared reflective film in the predetermined directions being reduction rates of lengths in the predetermined directions before versus after maintaining the infrared reflective film at 150° C. for 30 minutes.
(3) The thickness of the infrared reflective film is 80 μm or more and 120 μm or less.

By satisfying the requirement (1), the infrared reflective film has infrared reflectivity due to interference reflection. When the infrared reflective film satisfies the requirements (2) and (3), most of the factors that deform the infrared reflective film during the manufacturing of the windshield are eliminated. Accordingly, the windshield of the embodiment that has excellent heat shielding properties and that suppresses the generation of orange peel can be obtained. Hereinafter, the windshield of the present embodiment will be described with reference to the drawings.

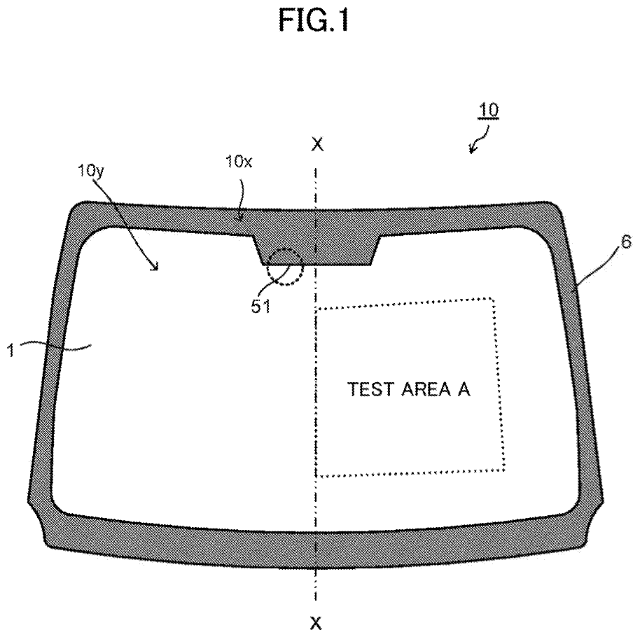

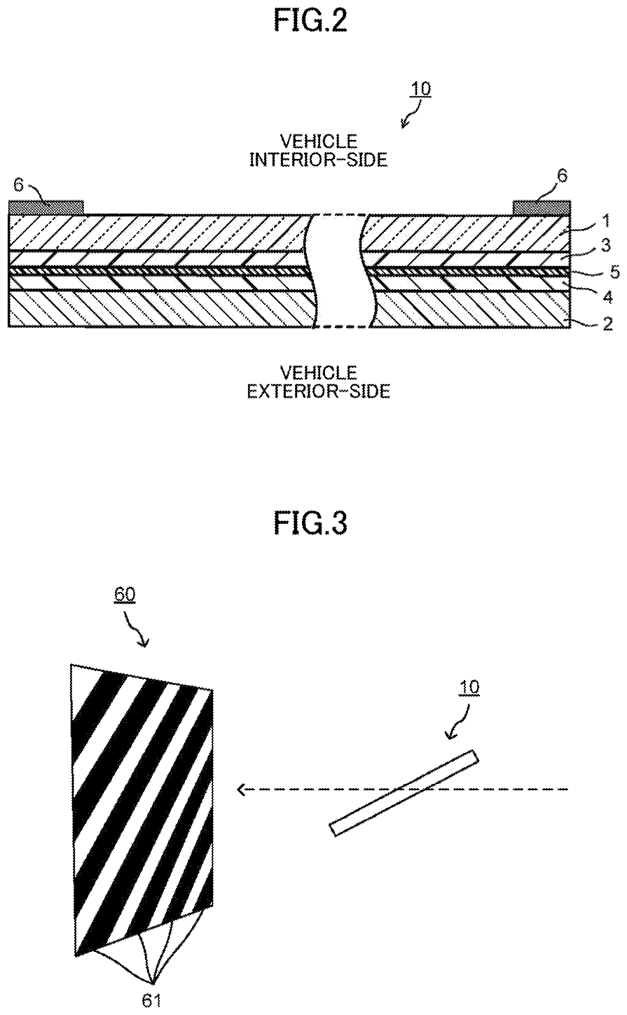

FIG. 1 is an example of a plan view of a laminated glass forming the windshield according to the embodiment. FIG. 1 is a plan view of a laminated glass seen from the vehicle interior-side. FIG. 2 is a cross-sectional view of the laminated glass taken along the line X-X of FIG. 1.

In the present specification, “upper” and “lower” indicate the upper side and the lower side of the windshield when the windshield is mounted on a vehicle, respectively. The “vertical direction” of the windshield indicates the vertical direction of the windshield when the windshield is mounted on a vehicle, and the direction orthogonal to the vertical direction is called the “width direction of the vehicle”.

In addition, in the present specification, the peripheral edge portion of the glass plate refers to a region having a certain width from the end portion of the glass plate toward the center of the main surface. In the present specification, the outer peripheral side portion of the main surface of the laminated glass for a vehicle viewed from the center of the main surface is referred to as the exterior-side, and the central side portion of the main surface viewed from the outer periphery of the main surface is referred to as interior-side. In the present specification, “substantially the same shape” and “same size” refer to a state when a person considers a shape is the same or a size is the same. In other cases, “substantially” has the same meaning as above. Further, “to” representing the numerical range includes the upper limit value and the lower limit value.

In FIGS. 1 and 2, a laminated glass 10 used as a windshield (hereinafter, also referred to as “windshield 10”) has a first glass plate 1, a first adhesive layer 3, an infrared reflective film 5, a second adhesive layer 4, and a second glass plate 2, in which each has a main surface of the same shape and the same size. In the windshield 10 of the present embodiment, the first glass plate 1 is arranged on the vehicle interior-side. The windshield 10 further has a black ceramic layer 6 arranged in a strip shape, in other words, in a frame shape, over the entire peripheral edge portion on the main surface of the vehicle interior-side of the first glass plate 1.

In the windshield of the present invention, the black ceramic layer is, for example, a component that is optionally provided in order to conceal the vehicle body mounting portion of the windshield and suppress the deterioration of the adhesive in that portion due to ultraviolet rays. In the windshield 10, a region having the black ceramic layer 6 in a plan view is referred to as a light shielding region 10x that does not transmit at least visible light, and a region excluding the light shielding region 10x is referred to as a transparent area 10y.

The top of the front view shown in FIG. 1 corresponds to the top of the windshield. The cross-sectional view of FIG. 2 is a cross-sectional view in which the left side of the drawing is on the windshield. Hereinafter, each component of the windshield 10 will be described.

### [Infrared Reflective Film]

The infrared reflective film 5 on the windshield 10 satisfies the above requirements (1) to (3). According to the requirement (1), the infrared reflective film includes a laminate in which 100 or more resin layers having different refractive indexes are laminated. The infrared reflective film 5 has infrared reflectivity by including the laminate. The infrared reflective film 5 may be formed from only the laminate, and may optionally have another layer, for example, a protective layer described later, as long as the effects of the invention are not impaired.

Regarding the requirement (1), in the infrared reflective film 5, the number of types of resin layers having different refractive indexes forming the laminate may be 2 or more, preferably 2 or more and 4 or less, and particularly 2, from the viewpoint of ease of production. When two types of resin layers having different refractive indexes are used, a resin layer having a relatively high refractive index is called a high refractive index layer and a resin layer having a low refractive index is called a low refractive index layer. In this case, the laminate is usually formed by alternately laminating high refractive index layers and low refractive index layers.

The refractive index of the resin layer is given as the refractive index of a wavelength of 589 nm measured using sodium D line as a light source. The high refractive index layer preferably has a refractive index in the range of 1.62 to 1.70, and the low refractive index layer preferably has a refractive index in the range of 1.50 to 1.58. Further, the difference in refractive index between the high refractive index layer and the low refractive index layer is preferably in the range of 0.05 to 0.20, more preferably in the range of 0.10 to 0.15.

The refractive index of the resin layer can be adjusted by appropriately adjusting the type of resin, the types of functional groups and skeletons in the resin, and the content of the resin. The resin constituting the resin layer is preferably a thermoplastic resin. Examples of the thermoplastic resin include polyolefin, alicyclic polyolefin, polyamide, aramid, acrylic resin, polyvinyl chloride, polyvinylidene chloride, polystyrene, styrene copolymer, polycarbonate, polyester, polyether sulfone, polyether ether ketone, modified polyphenylene ether, polyphenylene sulfide, polyetherimide, polyimide, polyarylate, fluorine-containing resin, and the like.

Two or more kinds of resins having different refractive indexes are appropriately selected from the above resins, and resin layers formed of the selected resins are laminated according to the above design to form a laminate. When selecting resins having different refractive indices, it is preferable to select a combination of resins containing the same repeating unit from the viewpoints of interlayer adhesion and the feasibility of a highly accurate laminated structure. Among the above resins, polyester is preferably used from the viewpoint of strength, heat resistance and transparency, and it is preferable to select a combination containing the same repeating unit from polyester. As the polyester to be selected, a polyester obtained by using an aromatic dicarboxylic acid or an aliphatic dicarboxylic acid and a diol or a derivative thereof is preferably used.

Examples of the polyesters include polyethylene terephthalate, polyethylene terephthalate copolymer, polyethylene naphthalate, polyethylene naphthalate copolymer, polybutylene terephthalate, polybutylene terephthalate copolymer, polybutylene naphthalate, polybutylene naphthalate copolymer, polyhexamethylene terephthalate, polyhexamethylene terephthalate copolymer, polyhexamethylene naphthalate, polyhexamethylene naphthalate copolymer, and the like. It is preferable to use one or more polyesters selected from the above polyesters.

Among these, the resin constituting the resin layer having a different refractive index is preferably a combination containing at least one type selected from polyethylene terephthalate (hereinafter referred to as “PET”) and polyethylene terephthalate copolymer (hereinafter referred to as “PET copolymer”). When the laminate is configured by alternately laminating two types of resin layers, for example, one resin layer is formed of PET, and the other resin layer is formed of PET copolymer, or a resin composed of a mixture of at least two types selected from PET and PET copolymer (hereinafter, also referred to as “mixed PET”).

The PET copolymer is composed of an ethylene terephthalate unit, which is the same repeating unit as PET, and a repeating unit having another ester bond (hereinafter, also referred to as “other repeating unit”). The proportion of other repeating units having an ester bond (hereinafter, also referred to as “copolymerization amount”) is preferably 5 mol % or more in order to obtain different refractive indexes. In addition, the amount of copolymerization is preferably 90 mol % or less because the adhesiveness between the layers is excellent, and further, the accuracy of the thickness of each layer and the uniformity of the thickness are excellent due to the small difference in heat flow characteristics. More preferably, the amount of the copolymerization is 10 mol % or more and 80 mol % or less.

When the mixed PET is a mixture of PET and a PET copolymer or a mixture of two or more kinds of PET copolymers, each component is preferably mixed in the mixture so that the content ratio of the other repeating units in the mixture become the same amount as that of the PET copolymer of the above.

The absolute value of the difference in glass transition temperature between resin layers having different refractive indexes is preferably 20° C. or less. When the absolute value of the difference in glass transition temperature is larger than 20° C., the uniformity of film thickness may be poor when the infrared reflective film including the laminate is formed, and the infrared reflectivity may vary. Further, there is a problem such as overstretching when molding an infrared reflective film including a laminate.

The mixed PET preferably contains, as another repeating unit, a repeating unit derived from spiroglycol as a raw material diol. Hereinafter, the repeating unit derived from the raw material component will be described by adding a unit to the raw material compound name. For example, a repeating unit derived from spiroglycol is referred to as “spiroglycol unit”. The mixed PET contains spiroglycol units means that the mixed PET contains a PET copolymer having spiroglycol units. The mixed PET may consist only of a PET copolymer having a spiroglycol unit, or may be a mixture of the PET copolymer and PET. In the following description, the mixed PET containing a unit of a specific compound means the same structure as the mixed PET containing a spiroglycol unit. Mixed PET containing a spiroglycol unit is preferable because it has a small difference in glass transition temperature from PET.

The mixed PET preferably contains, as another repeating unit, a cyclohexanedicarboxylic acid unit in addition to the spiroglycol unit. Since the mixed PET containing the spiroglycol unit and the cyclohexanedicarboxylic acid unit has a small glass transition temperature difference from PET and a large refractive index difference from PET, a laminate having high infrared reflectivity can be obtained.

When the mixed PET contains a spiroglycol unit and a cyclohexanedicarboxylic acid unit, the copolymerization amount of the spiroglycol unit is preferably 5 mol % to 30 mol % and the copolymerization amount of the cyclohexanedicarboxylic acid unit is preferably 5 mol % to 30 mol %.

The mixed PET also preferably contains a cyclohexanedimethanol unit as another repeating unit. Mixed PET containing a cyclohexanedimethanol unit is preferably used because the difference of the glass transition temperature of the mixed PET and that of PET is small.

When the mixed PET contains a cyclohexanedimethanol unit, the amount of copolymerization of the cyclohexanedimethanol unit is preferably 15 mol % or more and 60 mol % or less in order to achieve both infrared reflectivity and interlayer adhesion. Cyclohexanedimethanol has a cis or trans isomer as a geometrical isomer, and has a chair or boat type as a conformational isomer. Therefore, the mixed PET containing the cyclohexanedimethanol unit is less likely to be oriented and crystallized even when co-stretched with PET, has high infrared reflectivity, has less change in optical characteristics due to heat history, and is less likely to cause problems during film formation.

The intrinsic viscosity (IV) of the PET and the mixed PET used in the above is preferably 0.4 to 0.8, and more preferably 0.6 to 0.75 from the viewpoint of stability of film formation.

The combination of PET and mixed PET has been described above. In the present invention, the combination is not limited to the above, and different mixed PET may be combined depending on the required characteristics. In that case, a combination in which the types of units constituting the mixed PET are the same and the compositions of the repeating units are different is preferably used.

The laminate has a function of interfering and reflecting infrared rays by stacking 100 or more of such resin layers having different refractive indexes. When the number of laminated layers of the laminate is 100 or more, the number of laminated layers can be appropriately adjusted within a range in which the film thickness of the infrared reflective film 5 satisfies the requirement (3). In order to improve the infrared reflectivity, the number of resin layers is preferably 400 or more and more preferably 600 or more. The upper limit of the number of laminated layers of the laminate is limited by the upper limit of the film thickness of the infrared reflective film 5, and about 5000 layers are preferably used.

The number of resin layers laminated and the layer thickness of each resin layer in the laminate are designed based on the refractive index of the resin layer used, depending on the required infrared reflectivity. For example, when the A layer and the B layer are used as the two types of resin layers having different refractive indexes, the layer thickness distribution is that the optical thicknesses of the adjacent A layer and B layer satisfy the following formula (i).

λ=2(n_{A}d_{A}+n_{B}d_{B}) (i)

Here, A is the wavelength of reflected light, n_{A} is the refractive index of the A layer, d_{A} is the thickness of the A layer, n_{B} is the refractive index of the B layer, and d_{B} is the thickness of the B layer.

Further, the layer thickness distribution preferably satisfies the formula (i) and the following formula (ii) at the same time.

n_{A}d_{A}=n_{B}d_{B} (ii)

Even-order reflection can be eliminated by having the layer thickness distribution that simultaneously satisfies the formulae (i) and (ii). Thereby, for example, the average reflectance in the wavelength range of 400 nm to 700 nm (visible light) can be lowered while increasing the average reflectance in the wavelength range of 850 nm to 1200 nm (infrared ray). Accordingly, the infrared reflective film 5 which is transparent and has a high cut off property of heat energy can be obtained.

In addition to the formulae (i) and (ii), the 711711 structure (U.S. Pat. No. 5,360,659) for the layer thickness distribution is also preferably applied. The 711711 structure is a laminated structure in which 6 layers having A layer and the B layer are laminated in the order of ABABAB are used as one repeating unit and the ratio of optical thickness in one unit is 711711. Due to the layer thickness distribution having the 711711 structure, higher order reflections can be eliminated. Thereby, for example, the average reflectance in the wavelength range of 850 nm to 1400 nm can be increased and the average reflectance in the wavelength range of 400 nm to 700 nm can be decreased. Further, light in the wavelength range of 850 nm to 1200 nm may be reflected by the layer thickness distribution satisfying the formulae (i) and (ii) at the same time, and light in the wavelength range of 1200 nm to 1400 nm may be reflected by the layer thickness distribution of the 711111 structure. Light can be efficiently reflected with a small number of layers by applying the layer thickness structure as above.

Examples of the layer thickness distribution preferably include such that the layer thickness distribution increases or decreases from one surface of a film to the opposite surface thereof, the layer thickness distribution increases from one surface of a film to the center of the film thickness and then decreases from the center of the film to the opposite surface of the film, and the layer thickness distribution decreases from one surface of a film to the center of the film thickness and then increases from the center of the film to the opposite surface of the film. As a mode of change of the layer thickness distribution, a sequential change such as a linear change, a geometrical change, a stepwise change, or a step-like change such that layer thickness changed by almost the same layer thickness of about 10 to 50 layers is preferably applied.

The infrared reflective film 5 may have a resin layer having a layer thickness of 3 μm or more as a protective layer on both surface layers of the laminate. The thickness of the protective layer is preferably 5 μm or more, and more preferably 10 μm or more. When the thickness of the protective layer is increased, the effect of suppressing the flow mark and suppressing the ripple of the transmittance/reflectance spectrum can be obtained. However, the protective layer is provided in the range where the infrared reflective film 5 satisfies the requirements (1) and (3).

According to the requirement (3), the thickness of the infrared reflective film 5 is 80 μm or more and 120 μm or less. The infrared reflective film 5 has rigidity by having a thickness of 80 μm or more, and is hardly affected by thermal contraction of the first adhesive layer and the second adhesive layer during the production of laminated glass. Accordingly, the generation of orange peel can be suppressed. When the thickness of the infrared reflective film 5 is 120 μm or less, the degassing property during the production of laminated glass is favorable. The thickness of the infrared reflective film 5 is preferably 85 μm or more and 115 μm or less, more preferably 90 μm or more and 110 μm or less, and further preferably 95 μm or more and 110 μm or less.

According to the requirement (2), the infrared reflective film 5 has a thermal contraction rate in a direction which the thermal contraction rate being maximum (hereinafter also called “direction for maximum contraction”) of 1.5% or more and 2.0% or less, and has a thermal contraction rate in a direction orthogonal to the direction hereinafter also called “orthogonal direction”) of 1.5% or more and 2.0% or less.

However, the thermal contraction rates of the infrared reflective film in the predetermined directions being reduction rates of lengths in the predetermined directions before versus after maintaining the infrared reflective film at 150° C. for 30 minutes. Specifically, the thermal contraction rate of the infrared reflective film can be measured as follows.

First, a strip-shaped test piece is cut out from the infrared reflective film 5 along the direction for maximum contraction or the orthogonal direction thereto. The infrared reflective film has residual stress due to stretching, because the infrared reflective film is manufactured by stretching the constituent materials into a film as described below. In particular, the residual stress in the longitudinal direction which is the flow direction at the time of film production, that is, the so-called MD direction, is large and thermal contraction is likely generated. Therefore, normally, the MD direction is the direction for maximum contraction and the TD direction which is the width direction is the orthogonal direction.

The dimensions of the test piece are, for example, 150 mm in length and 20 mm in width. On this test piece, a pair of reference lines are written at intervals of about 100 mm in the longitudinal direction, and the length L₁ between the reference lines is measured. The test piece is hung vertically in a hot air circulation oven, heated to 150° C. and maintained for 30 minutes. The test piece is naturally cooled to room temperature and maintained for 60 minutes, and then the length L₂ between the reference lines is measured. The thermal contraction rate is calculated by the following formula (iii) by substituting the L₁ and L₂ obtained above.

Thermal contraction rate=((L₁−L₂)/L₁)×100[%] (iii)

The generation of orange peel in the infrared reflective film 5 can be suppressed when the thermal contraction rate in the direction for maximum contraction of the film and the orthogonal direction of the film is 1.5% or more, and the generation of transparent warp of the laminated glass can be suppressed when the thermal contraction rate is 2.0% or less. The thermal contraction rate in a direction in which the thermal contraction rate being maximum is preferably 1.6% or more and 2.0% or less and more preferably 1.8% or more and 2.0% or less. The thermal contraction rate in a direction orthogonal to the direction is preferably 1.6% or more and 2.0% or less and more preferably 1.75% or more and 2.0% or less. Further, a small difference between the thermal contraction rate in the direction for maximum contraction and the thermal contraction rate in the orthogonal direction is favorable. The thermal contraction rate in the direction for maximum contraction and the thermal contraction rate in the orthogonal direction being the same is particularly favorable.

The infrared reflective film 5 satisfying the requirements (1) to (3) can be produced, for example, by the following method. In addition, below, the method of producing the infrared reflective film 5 which consists of a laminate using the A layer formed of resin A and the B layer formed of resin B is exemplified as two types of resin layers having different refractive indexes. An infrared reflective film using three or more kinds of resin layers or an infrared reflective film having another layer such as a protective layer can be produced by appropriately changing the method.

The infrared reflective film formed by a laminate using the A layer and the B layer can be produced by a method including the following steps (a) to (c). When the infrared reflective film satisfying all the above requirements (1) to (3) is obtained in the steps (a) and (b), the step (c) is not performed. That is, the step (c) can be an optional step.

(a) A step of producing an unstretched laminate in which A layers and B layers are alternately laminated so that the layer thickness is different from that of the finally obtained laminate but the number of layers is the same.
(b) A step of stretching the unstretched laminate obtained in the step (a) to adjust the layer thickness to obtain a laminate precursor.
(c) A step of heat-treating the laminate precursor after the step to obtain a laminate having a thermal contraction adjusted to satisfy the requirement (2).

### (a) Step of Producing Unstretched Laminate

Resin A and resin B are prepared in the form of pellets or the like. The pellets are pre-dried in hot air or under vacuum, as needed, and then supplied to the extruder. In the extruder, the resin that has been heated and melted at a temperature equal to or higher than the melting point has a uniform amount of resin extruded by a gear pump or the like, and foreign matter and modified resin are removed through a filter or the like.

The resin A and the resin B sent out from different flow paths by using two or more extruders are then transferred to a multi-layer laminating apparatus to be a molten laminate in which a desired number of layers is laminated by the apparatus. Then, the molten laminate is formed into a desired shape with a die and discharged. The multilayered sheets discharged from the die are extruded onto a cooling body such as a casting drum, and the sheets are cooled and solidified to form an unstretched laminate. A multi-manifold die, a field block, a static mixer, or the like can be used as the multi-layer laminating apparatus.

### (b) Step of Stretching

The unstretched laminate obtained in the step (a) is stretched to prepare a laminate precursor. The stretching method is usually biaxial stretching. The biaxial stretching method may be either sequential biaxial stretching or simultaneous biaxial stretching. Furthermore, re-stretching may be performed in the MD direction and/or the TD direction. Simultaneous biaxial stretching is preferred from the viewpoint of suppressing in-plane orientation difference and suppressing surface scratches. The biaxial stretching is preferably carried out at a temperature not lower than the glass transition temperature of the resin having the higher glass transition point of the resin A and the resin B but not higher than the temperature+120° C.

The stretching ratios in the MD direction and the TD direction are adjusted so that the layer thickness of each layer in the obtained laminate is the designed layer thickness. Further, preferably, the stretching ratio and the stretching speed are adjusted so that the residual stress in the MD direction and the TD direction are almost the same. The laminate precursor obtained in the stretching step usually has high residual stress and does not satisfy the requirement (2) in the infrared reflective film. Then, the following heat treatment (c) is performed to obtain a laminate satisfying the requirement (2). However, as described above, when the laminate precursor satisfies the requirement (2), the laminate precursor may be used as it is as a laminate.

### (C) Step of Heat Treatment

The heat treatment of the laminate precursor is generally performed in a stretching machine. The heat treatment temperature is preferably lower than the melting point of the resin having a higher melting point between the resins A and B. Also, the heat treatment temperature is preferably higher than the melting point of the resin having a lower melting point between the resins A and B. As a result, the resin having the higher melting point maintains the high orientation state, while the orientation of the resin having the lower melting point is relaxed, so that the difference in refractive index between these resins can be easily provided. Further, the stress of the thermal contraction is easily reduced as the orientation is relaxed. Thereby, the thermal contraction rate of the laminate can be easily adjusted within the range of (2).

Note that the heat treatment may be performed so that the relaxation rate at the time of heat treatment is 0% or more and 10% or less and preferably 0% or more and 5% or less. The relaxation may be performed in one or both of the TD direction and the MD direction. It is also preferable to perform a fine stretching of 2% or more and 10% or less during the heat treatment. The fine stretching may be performed in one or both of the TD direction and the MD direction. In this way, the heat treatment temperature, the heat treatment time, the relaxation rate and the fine stretching rate are adjusted so that the thermal contraction rate of the laminate falls within the range of (2).

In addition, for the purpose of adjusting the thermal contraction rate of the laminate, a thermal relaxation may be performed during cooling after the heat treatment step, and further, fine stretching may be performed after the heat treatment step.

In the windshield 10, the infrared reflective film 5 is placed so that the direction for maximum contraction of the film substantially coincides with the vertical direction of the windshield 10 or the vehicle width direction. In this case, substantially coincides is defined such that the angle deviation of each component forming the infrared reflective film is within ±5°.

### [Adhesive Layer]

The first adhesive layer 3 and the second adhesive layer 4 in the windshield 10 have main surfaces of the same shape and the same size as the main surfaces of the first glass plate 1 and the second glass plate 2, and the formation of the thicknesses of the adhesive layers are flat layers as described later. The first adhesive layer 3 and the second adhesive layer 4 are inserted between the first glass plate 1 and the second glass plate 2 while sandwiching the infrared reflective film 5 therebetween. The adhesive layer has a function to adhere these and has a function to integrate to form the windshield 10 as a whole.

The first adhesive layer 3 and the second adhesive layer 4 can be the same configuration except the position placed on the windshield 10. Hereinafter, the first adhesive layer 3 and the second adhesive layer 4 will be collectively described as “adhesive layer”.

The adhesive layer is formed of an adhesive layer containing a thermoplastic resin used for an ordinary laminated glass adhesive layer. The kind of the thermoplastic resin is not particularly limited, and can be appropriately selected from the known thermoplastic resins forming the adhesive layer.

Examples of the thermoplastic resin include polyvinyl acetal such as polyvinyl butyral (PVB), polyvinyl chloride (PVC), saturated polyester, polyurethane, ethylene-vinyl acetate copolymer (EVA), ethylene-ethyl acrylate copolymer, cycloolefin polymer (COP), and the like. The thermoplastic resins may be used alone or in combination of two or more kinds.

The thermoplastic resin is selected in consideration of the balance of various properties such as glass transition point, transparency, weather resistance, adhesive strength, penetration resistance, impact energy absorption, moisture resistance, and heat shielding property. The glass transition point of the thermoplastic resin can be adjusted, for example, by the amount of a plasticizer. Considering the balance of the above performances, the thermoplastic resin used for the adhesive layer is preferably PVB, EVA, polyurethane or the like. Furthermore, PVB is particularly preferable in consideration of reducing the amount of deformation of the infrared reflective film 5 when the windshield 10 is produced.

The adhesive layer contains a thermoplastic resin as a main component. The adhesive layer contains a thermoplastic resin as a main component, indicates that the content of the thermoplastic resin with respect to the total amount of the adhesive layer is 30% by mass or more. The adhesive layer may contain one kind or two or more kinds of various additives such as an infrared absorber, an ultraviolet absorber, a fluorescent agent, an adhesion modifier, a coupling agent, a surfactant, an antioxidant, a heat stabilizer, a light stabilizer, a dehydrating agent, a defoaming agent, an antistatic agent, a flame retardant, and the like.

In the adhesive layer, a thermal contraction rate in a direction in which a thermal contraction rate being maximum (hereinafter, also referred to as “direction for maximum contraction” similarly to the infrared reflecting film) is preferably 2.0% or more and 8.0% or less, and the thermal contraction rate in a direction orthogonal to the direction (hereinafter, also referred to as “orthogonal direction” similarly to the infrared reflecting film) is preferably 2.0% or more and 8.0% or less. The thermal contraction rate in a direction in which a thermal contraction rate being maximum in the adhesive layer is preferably 4.0% or more and 7.0% or less, and the thermal contraction rate in the direction orthogonal to the direction is preferably 4.0% or more and 7.0% or less.

The thermal contraction rate of the adhesive layer is a reduction ratio of length in the specified direction of the adhesive layer before and after heat treatment. When the time point at leaving the adhesive layer for 24 hours or more in the constant temperature and humidity environment of the temperature of 20° C. and the humidity of 55% is regarded as before heat treatment. Then, when the time point cooling the adhesive layer in a desiccator at 20° C. for 1 hour after keeping the adhesive layer at 50° C. for 10 minutes is regarded as after heat treatment. The thermal contraction rate of the adhesive layer is similarly measured as the thermal contraction rate of the infrared reflective film except that the heat treatment temperature and the test time are changed to at 50° C. for 10 minutes, and pretreatment and posttreatment are performed before and after the heat treatment.

In the same manner as the infrared reflective film 5, the adhesive layer is produced by stretching the constituent materials into a film. Since the residual stress is large in the MD direction, which is the flow direction at the time of producing the adhesive layer, the adhesive layer is likely to be heat-shrunken. Therefore, normally, the MD direction is the direction for maximum contraction and the TD direction which is the width direction is the orthogonal direction. When the windshield 10 is produced by laminating the infrared reflective film 5 so that the direction for maximum contraction of the infrared reflective film 5 coincides with the direction for maximum contraction of the adhesive layer, the infrared reflective film 5 is likely to be deformed.

Therefore, in the windshield 10, the adhesive layer is preferably placed so that the direction for maximum contraction of the infrared reflective film 5 and the direction for maximum contraction of the adhesive layer are orthogonal to each other. The direction for maximum contraction of the adhesive layer and that of the infrared reflective film are preferably completely orthogonal to each other, but if the angle deviation from the completely orthogonal state is within ±5° for each adhesive layer, it is allowable.

Further, in the windshield 10, the value (H) in which the thermal contraction rate in the direction in which the thermal contraction rate of the infrared reflective film 5 being maximum divided by the average value of the thermal contraction rate in the direction in which the thermal contraction rate of the first adhesive layer 3 and the second adhesive layer 4 being maximum is 0.2 or more and 0.6 or less. When the numerical value H is 0.2 or more, the deformation load of the infrared reflective film due to the contraction of the adhesive layer becomes small, and the appearance defect such as orange peel or wrinkle hardly occurs. When the numerical value H is 0.6 or less, the thermal contraction rate of the adhesive layer and the infrared reflective film do not come too close to each other, the contraction of the infrared reflective film does not accelerate, and an appearance defect does not likely occur due to the infrared reflective film being pulled inward.

The film thicknesses of the first adhesive layer 3 and the second adhesive layer 4 are not particularly limited. Specifically, the thicknesses of the adhesive layers are preferably 0.3 to 0.8 mm in the same manner as an adhesive layer usually used for laminated glass for vehicles. The total thickness of the first adhesive layer 3 and the second adhesive layer 4 is preferably 0.7 to 1.5 mm. When the thickness of each adhesive layer is less than 0.3 mm or the total thickness of the two layers is less than 0.7 mm, the strength may be insufficient even when the two layers are combined. Conversely, when the thickness of each adhesive layer exceeds 0.8 mm or the total thickness of the two layers exceeds 1.5 mm, in some cases, a so-called plate misalignment phenomenon may occur between the first glass plate 1 and the second glass plate 2 in which these are sandwiched in the main bonding (main pressure bonding) step by the autoclave at the time of producing the windshield 10, which will be described later.

The adhesive layer is not limited to a single layer structure. For example, Japanese Patent Application Laid-Open No. 2000-272936 discloses a multilayer resin film, which is used for the purpose of improving sound insulation performance and has different properties (different loss tangents), that may be used as an adhesive layer. Further, in the windshield 10, the adhesive layer may be designed so that the vertical cross-sectional shape is wedge-shaped. As the wedge shape, the thickness of the adhesive layer may monotonically decrease from the upper side to the lower side, or the rate of change of the thickness may be partially different as long as the thickness of the upper side is larger than the thickness of the lower side. Alternatively, the design may have a part having a uniform thickness.

### [Glass Plate]

Although the thicknesses of the first glass plate 1 and the second glass plate 2 in the windshield 10 differ depending on the composition thereof and the compositions of the first adhesive layer 3 and the second adhesive layer 4, thicknesses of glass plates in windshields are generally 0.1 to 10 mm.

Of the first glass plate 1 and the second glass plate 2, the thickness of the first glass plate 1 on the vehicle interior-side is preferably 0.5 to 2.0 mm and more preferably 0.7 to 1.8 mm. The thickness of the second glass plate 2 on the vehicle exterior-side is preferably 1.6 mm or more because the impact resistance by a flying stone is favorable. The difference in thickness between the two is preferably 0.3 to 1.5 mm and more preferably 0.5 to 1.3 mm, and the second glass plate 2 is preferably thicker than the first glass plate 1. The thickness of the second glass plate 2 on the vehicle exterior-side is preferably 1.6 to 2.5 mm and more preferably 1.7 to 2.1 mm.

From the viewpoint of weight reduction, the total thickness of the first glass plate 1 and the second glass plate 2 is preferably 4.1 mm or less. The total thickness is more preferably 3.8 mm or less, further preferably 3.6 mm or less.

The first glass plate 1 and the second glass plate 2 can be formed of inorganic glass or organic glass (resin). Examples of the inorganic glass include ordinary soda lime glass (also referred to as soda lime silicate glass), aluminosilicate glass, borosilicate glass, non-alkali glass, quartz glass and the like. Of these, soda lime glass is particularly preferable. Examples of the inorganic glass include float plate glass formed by the float method or the like. As the inorganic glass, glass that has been subjected to tempering treatment such as air-cooled tempering or chemical tempering can also be used.

Examples of the organic glass (resin) include polycarbonate resin, polystyrene resin, aromatic polyester resin, acrylic resin, polyester resin, polyarylate resin, polycondensate of halogenated bisphenol A and ethylene glycol, acrylic urethane resin, acrylic resins containing halogenated aryl group, and the like. Of these, polycarbonate resins such as aromatic polycarbonate resins and acrylic resins such as polymethylmethacrylate acrylic resins are preferably used, and polycarbonate resins are more preferably used. Further, among the polycarbonate resins, the bisphenol A-based polycarbonate resin is particularly preferably used. Two or more kinds of the above resins may be used in combination.

The glass may contain an infrared absorber, an ultraviolet absorber or the like. Examples of such glass include green glass, ultraviolet absorbing (UV) green glass, and the like. The UV green glass contains SiO₂ of 68% by mass or more and 74% by mass or less, Fe₂O₃ of 0.3% by mass or more and 1.0% by mass or less, and FeO of 0.05% by mass or more and 0.5% by mass or less. In the UV glass, the ultraviolet transmittance at a wavelength of 350 nm has a minimum value of the transmittance of 1.5% or less in the region of 550 nm or more and 1700 nm or less.

The glass may be transparent and may be colorless or colored. Further, the glass may be a laminate of two or more layers. Inorganic glass is preferably used depending on a place where an inorganic glass applies.

The materials of the first glass plate 1 and the second glass plate 2 may be the same or different, but are preferably the same. The shapes of the first glass plate 1 and the second glass plate 2 may be flat plates, or may have a curvature on the entire surface or a part thereof. The surfaces of the first glass plate 1 and the second glass plate 2 that are exposed to the atmosphere may be coated with a water-repellent function, a hydrophilic function, an antifogging function, or the like. Further, the opposing surfaces of the first glass plate 1 and the second glass plate 2 may be usually coated with a low radiation coating, an infrared ray shielding coating, a conductive coating, and the like, but usually coated with a metal layer.

### [Black Ceramic Layer]

The black ceramic layer is optionally provided in the windshield of the present invention. In the windshield 10, the black ceramic layer 6 is placed in a frame shape on the main surface of the vehicle interior-side of the first glass plate 1. When the windshield 10 has the black ceramic layer 6, the black ceramic layer 6 does not necessarily have to be formed in a strip shape on all four sides of the peripheral edge portion, and may be formed in a strip shape on a part of the peripheral edge portion.

The width of the black ceramic layer 6 is a width capable of concealing a region that requires concealment. In the windshield 10, the width of the black ceramic layer 6 is set to be wider on the lower side than on the other three sides in order to hide the storage portion such as the wiper. In addition, in the upper side, for example, the central part is designed to be wide so that a mounting part such as a communication device, an information acquisition device, or a room-view mirror, and the like are concealed, and the other parts are designed to be narrow.

Specifically, the width of the black ceramic layer 6 is preferably in the range of 50 to 300 mm, and more preferably 100 to 200 mm, as the width of the lower side and the width of the widely designed portion of the upper side. Further, the width of the black ceramic layer 6 provided along the portion where the width of the upper side is designed to be narrow and along the left and right sides is preferably in the range of 5 to 50 mm and more preferably 10 to 30 mm. The widths of the top, the left, and the right may be the same or different.

Here, the “black” of the black ceramic layer does not mean, for example, black defined by the three attributes of color. The color includes colors recognized as black which is adjusted so that visible light is not transmitted at least to the extent that the portion where hiding is required can be hidden. Therefore, in the black ceramic layer, the black color may have shades within the range where the shielding function can be performed, and the tint may be slightly different from black defined by the three attributes of color. From the same viewpoint, the black ceramic layer may be configured so that the entire layer becomes a continuous integral film depending on the location where it is disposed, and the visible light transmission ratio can be easily adjusted by setting the shape and arrangement. The configuration may be achieved by a dot pattern or the like.

As the black ceramic layer 6, a black ceramic layer formed on the first glass plate 1 by a conventionally known method can be applied without particular limitation. Specifically, a black ceramic paste obtained by adding a powder of a heat-resistant black pigment to a resin and a solvent together with a low-melting glass powder and kneading is applied to a desired region of the first glass plate 1 on the vehicle interior-side by printing or the like. Then, a black ceramic layer is formed by heating and baking. Further, the black pigment used for forming the black ceramic layer includes a combination of pigments that become black by combining a plurality of colored pigments.

The thickness of the black ceramic layer 6 is not particularly limited as long as a visibility can be obtained without problems. The black ceramic layer 6 is preferably formed with a thickness of about 8 to 20 μm and more preferably 10 to 15 μm.

Note that, according to need, the black ceramic layer 6 may be provided on the main surface of the vehicle exterior-side of the first glass plate 1, the main surface of the vehicle interior-side of the second glass plate 2, or the main surface of the vehicle exterior-side of the second glass plate 2.

### [Laminated Glass]

The laminated glass constituting the windshield of the present invention preferably has a visible light reflectance measured from the vehicle exterior-side of 7% or more and 10% or less. In this specification, when the laminated glass 10 has the black ceramic layer 6 as illustrated in FIG. 1, the optical characteristics of the laminated glass, is the characteristics of the transparent region 10 which does not have the black ceramic layer 6 in a plan view.

In the laminated glass 10, when the visible light reflectance (Rv) measured from the vehicle exterior-side is 7% or more, the function of the infrared reflective film 5 is sufficient, that is, the heat shielding property is sufficient. When the visible light reflectance (Rv) is 10% or less, orange peel is not noticeable. The visible light reflectance (Rv) is more preferably 7.5% or more and 10.0% or less.

The laminated glass 10 preferably has a solar radiation transmittance (Te) of 45% or less and a visible light transmittance (Tv) of 70% or more. The solar radiation transmittance (Te) is more preferably 40% or less and particularly preferably 38% or less. The solar radiation reflectance (Re) measured from the vehicle exterior-side is more preferably 18% or more and particularly preferably 20% or more. The visible light transmittance (Tv) is more preferably 72% or more and particularly preferably 73% or more. The haze value of the laminated glass 10 is preferably 1.0% or less, more preferably 0.8% or less, and particularly preferably 0.6% or less.

The visible light reflectance (Rv) measured from the vehicle exterior-side, the solar radiation reflectance (Re) measured from the vehicle exterior-side, the solar radiation transmittance (Te), and the visible light transmittance (Tv) are measured by a spectrophotometer by measuring the transmittance and the reflectance of the wavelength of 300 to 2100 nm. The values of transmittance and reflectance are calculated by the formula defined in JIS R3106 (1998) and JIS R3212 (1998), respectively. In the present specification, unless otherwise specified, visible light reflectance, solar reflectance, solar radiation transmittance, and visible light transmittance are the visible light reflectance measured from the vehicle exterior-side (Rv), the solar radiation reflectance (Re), the solar radiation transmittance (Te) and the visible light transmittance (Tv). These are the ones measured and calculated of the above method.

Furthermore, the color tone of the reflected light obtained by irradiating the laminated glass 10 with the light from the D65 light source from the vehicle exterior-side in the incident angle range of 10 to 60° is preferably −5<a*<3 and −12<b*<2 in CIE1976L*a*b* chromaticity coordinates. When the values of a* and b* measured under the above conditions are out of the above ranges, orange peel become remarkable. The a* measured under the above conditions is more preferably −3<a*<2. The b* measured under the above conditions is more preferably −9<b*<0.

Further, in a test area A (hereinafter, simply referred to as “test area A”) defined by JIS R3212 (1998) for windshields for vehicles, the radius of curvature of the laminated glass is preferably 900 mm or less. The orange peel is not remarkable because the radius of curvature is 900 mm or less. The radius of curvature is more preferably 880 mm or less, further preferably 860 mm or less, and further more preferably 850 mm or less. It is not clear why the orange peel is less noticeable when the radius of curvature is less than or equal to the above upper limit, but it is derived as a result of the inventors' investigation. The fact that the radius of curvature of the laminated glass is 900 mm or less in the test area A indicates that there is no portion in the test area A of the laminated glass having a radius of curvature of more than 900 mm. That is, the maximum radius of curvature in the test area A is 900 mm or less.

In the test area A, the radius of curvature of the laminated glass is preferably 700 mm or more. When the radius of curvature is 700 mm or more, defects such as wrinkles are less likely to occur in the infrared reflective film. The radius of curvature is more preferably 750 mm or more. The fact that the radius of curvature of the laminated glass in the test region A is 700 mm or more indicates that there is no portion in the test region A of the laminated glass having a radius of curvature of less than 700 mm. That is, the minimum radius of curvature in the test area A is 700 mm or more.

The test area A is, in detail, a test area defined as “A test area of a safety glass used for the front” defined in JIS R3212 (1998, “Test method for safety glass for automobiles”). FIG. 1 schematically shows the test area A in the case of the right steering wheel.

The distance between the inner peripheral edge of the black ceramic layer 6 and the outer peripheral edge of the infrared reflective film 5 is preferably 5 mm or more, more preferably 7 mm or more, and furthermore preferably 10 mm in the portion where the black ceramic layer 6 and the infrared reflective film 5 overlap in a plan view. When the distance is in the above range, transparent warp can be suppressed.

### [Production of Windshields]

The windshield of the present invention can be produced by a commonly used known technique. In the windshield (laminated glass) 10, the first glass plate, the first adhesive layer, the infrared reflective film, the second adhesive layer, and the second glass plate, in which these are prepared as described above, are laminated in this order by pressure bonding so that a laminated glass precursor is prepared. At that time, according to need, the TD direction and the MD direction of the first adhesive layer, the infrared reflective film, and the second adhesive layer are aligned and laminated in preferable directions. The laminated glass precursor is placed in a vacuum bag such as a rubber bag. The vacuum bag is connected to an exhaust system, and heated to about 70 to 110° C. while applying vacuum suction (degassing) so that the pressure inside the vacuum bag is to be about −65 to −100 kPa (absolute pressure is about 36 to 1 kPa). Thereby, a laminated glass in which the first glass plate, the first adhesive layer, the infrared reflective film, the second adhesive layer, and the second glass plate are entirely bonded is obtained. Thereafter, if necessary, the laminated glass is put into an autoclave, and a pressure bonding process is performed by heating and pressing under conditions of a temperature of about 120 to 150° C. and a pressure of about 0.98 to 1.47 MPa. The pressure bonding process can further improve the durability of the laminated glass.

### EXAMPLES

Hereinafter, the present invention will be described in more detail with reference to Examples. The present invention is not limited to the embodiments described below.

### Examples 1 to 11

A laminated glass having the same configuration as the laminated glass illustrated in FIGS. 1 and 2 was produced and evaluated as follows. Examples 1 to 7 are Examples, and Examples 8 to 11 are Comparative Examples.

### (Production of Infrared Reflective Film)

Resin A and resin B were used as two types of thermoplastic resins having different refractive indexes. As the resin A, PET (crystalline polyester, melting point 255° C.) having an intrinsic viscosity IV=0.65 and a refractive index 1.66 was used. As the resin B, a PET copolymer (PE/SPG⋅T/CHDC) having an intrinsic viscosity IV=0.73 and a refractive index of 1.55 and containing 25 mol % of spiroglycol units, and 30 mol % of cyclohexanedicarboxylic acid units based on all the units was used. The two kinds of prepared resins were melted at 280° C. by an extruder, and 2000 layers were alternately laminated in the thickness direction so that the optical thickness ratio is to be resin A/resin B=1 to obtain an unstretched laminate.

In each example, the unstretched laminate was biaxially stretched at a predetermined ratio to adjust the thickness of the laminate, and then subjected to heat treatment to adjust the residual stress (thermal contraction rate) in the MD direction and the TD direction. An infrared reflective film having the physical properties shown in Table 1 was obtained. Regarding the thermal contraction rate shown in Table 1, the “direction for maximum thermal contraction” corresponds to the direction in which the thermal contraction rate is maximum, and is specifically the MD direction of the infrared reflective film. The “orthogonal direction” shown in Table 1 is a direction orthogonal to the “direction for maximum thermal contraction” and is the TD direction of the infrared reflective film. The thermal contraction rate of the infrared reflective film is a reduction rate of the length in a predetermined direction before and after holding the infrared reflective film at 150° C. for 30 minutes, and is a value measured by the above method.

### (Production of Laminated Glass)

A heat ray absorbing green glass (manufactured by Asahi Glass Co., Ltd.: NHI (common name)) having a length of 1000 mm, a width of 1400 mm, and a plate thickness of 2 mm was used as the first glass plate. A clear glass (manufactured by Asahi Glass Co., Ltd.: FL (common name)) in which the outer peripheral size in a front view was 1000 mm in length, 1400 mm in width, and a plate thickness of 2 mm was used as the second glass plate. Two kinds of glass plates A and B having different radii of curvature in the test area A were prepared by bending the respective glasses by heating so as to have a predetermined curvature. The maximum radius of curvature of the glass plate A in the test area A was 860 mm, and that of the glass plate B was 1050 mm.

Here, the same radius of curvature and the same kind of glass were used in the first glass plate and the second glass plate in the production of laminated glass. In Example 5, the glass plate B was used, and in other examples, the glass plate A was used. Further, a black ceramic layer was formed in a frame shape on the peripheral edge portion of the main surface on the vehicle interior-side of the glass plate that became the first glass plate.

The first adhesive layer was a PVB film having a thickness of 0.76 mm (Eastman Chemical Company: product number QL51), and the second adhesive layer was a PVB film having a thickness of 0.38 mm (Eastman Chemical Company: product number RK11). In the two types of PVB films having different thicknesses, the direction in which the thermal contraction rate becomes maximum, specifically, the thermal contraction rate in the MD direction was 6.0%, and the direction orthogonal to the direction for maximum thermal contraction, specifically, the thermal contraction rate in the TD direction was 5.0% in all cases. In addition, the thermal contraction rate of the PVB film was a value obtained by measuring the PVB film by the above method. Furthermore, two kinds of adhesive layers having different thermal contraction rates from the above were prepared by adjusting the stretching method. In each case, the first adhesive layer was a PVB film having a thickness of 0.76 mm, and the second adhesive layer was a PVB film having a thickness of 0.38 mm. One of the adhesive layers had a thermal contraction rate in the MD direction of 8.5% and a thermal contraction rate in the TD direction of 7.0%. The other adhesive layer had a thermal contraction rate in the MD direction of 3.0% and a thermal contraction rate in the TD direction of 2.0%.

A laminate in which a first glass plate, a first adhesive layer, an infrared reflective film, a second adhesive layer, and a second glass plate were laminated in this order with use of the infrared reflective film obtained above was prepared in each example. The first adhesive layer, the infrared reflective film, and the second adhesive layer were laminated such that the MD direction was aligned with the lateral direction of the first glass plate and the second glass plate. In addition, the first glass plate was laminated such that the black ceramic layer was on the opposite side of the first adhesive layer. The laminate was placed in a vacuum bag, and the bag was degassed so that the pressure gauge display showed 100 kPa or less. Then, the bag was heated to 120° C. so that the laminate in the bag was subjected to pressure bonding. Further, the laminate in the bag was heated at 135° C. and pressurized at 1.3 MPa for 60 minutes in an autoclave. Finally, a laminated glass was obtained by cooling the laminate.

In the laminated glass obtained in each example, visible light reflectance (Rv) and solar reflectance (Re) were measured. Also, the a* and b* in the CIE1976L*a*b* in the chromaticity coordinates of the reflected light obtained by irradiating the light from the D65 light source from the vehicle exterior-side at an incident angle of 100 were measured. A spectrophotometer (U4100 manufactured by Hitachi High Technology) was used for the measurement. Table 1 shows the obtained results, along with the radius of curvature of the glass plate used in examples.

### [Evaluation]

In the obtained laminated glass, an orange peel, a wrinkle, a foaming, a transparent warp, a heat shielding property, and a state of a film being pulled inward were evaluated.

### <Orange Peel>

The laminated glass was horizontally placed in the state in which the background of the glass was dark. A straight tube fluorescent light (630 mm in length, 30 W, FL30SW manufactured by Mitsubishi Electric Lighting Co., Ltd.) was placed 180 cm above from the laminated glass so that the longitudinal direction of the fluorescent light and the width direction of the laminated glass were in the same direction. Then, the fluorescent light was turned on. The position of the fluorescent light was adjusted to be directly above the center of the transparent area 10y of the laminated glass, and the presence or absence of fluctuation in the contour of the fluorescent light reflection image in the center was visually observed. Similarly, the position of the fluorescent light was adjusted so as to be directly above the lower side of the transparent area 10y of the laminated glass, and the presence or absence of fluctuation in the contour of the fluorescent light reflection image near the lower side was visually observed. The observation results were evaluated according to the following criteria.

A: No fluctuation was observed in the contour of the fluorescent light reflection image.
B: Fluctuation was recognized in a part of the contour of the fluorescent light reflection image in the central portion or near the lower side.
C: Fluctuations were observed in about half of the contour of the fluorescent light reflection image in the central portion and near the lower side (remarkable defects).

### <Wrinkles>

Regarding the transparent area 10y of the laminated glass, the presence or absence of wrinkles in the infrared reflective film was visually observed at the peripheral edge portion along the entire outer circumference, and evaluated according to the following criteria.

A: No wrinkles were found on the infrared reflective film at the entire peripheral edge portion of the transparent area 10y of the laminated glass.
B: A slight wrinkle was observed at a part of the peripheral edge portion of the transparent area 10y of the laminated glass.
C: Wrinkles were observed at a part of the peripheral edge portion of the transparent area 10y of the laminated glass.

### <Foaming>

Regarding the transparent area 10y of the laminated glass, the presence or absence of whitening due to air entrainment at the peripheral edge portion along the entire outer circumference was visually observed and evaluated according to the following criteria.

A: Whitening was not observed at the entire peripheral edge portion of the transparent area 10y of the laminated glass.
C: Whitening was observed at a part of the peripheral edge portion of the transparent area 10y of the laminated glass.

### <Transparent Warp>

First, as shown in FIG. 3, the laminated glass 10 was placed with inclined angle in the same inclined angle as attaching the laminated glass 10 to the vehicle, and the zebra pattern 60 was placed vehicle exterior-side. The zebra pattern 60 had a plurality of black lines 61 provided on a white background. The black lines 61 were provided so as to form an angle of 45 degrees with respect to the lower side of the zebra pattern 60 and were parallel to each other.

The transparent warp was evaluated based on the state of warp of the zebra pattern 60 that generated near the boundary between the transparent area 10y and the light shielding area 10x when the zebra pattern 60 was viewed from the vehicle interior-side of the laminated glass 10.

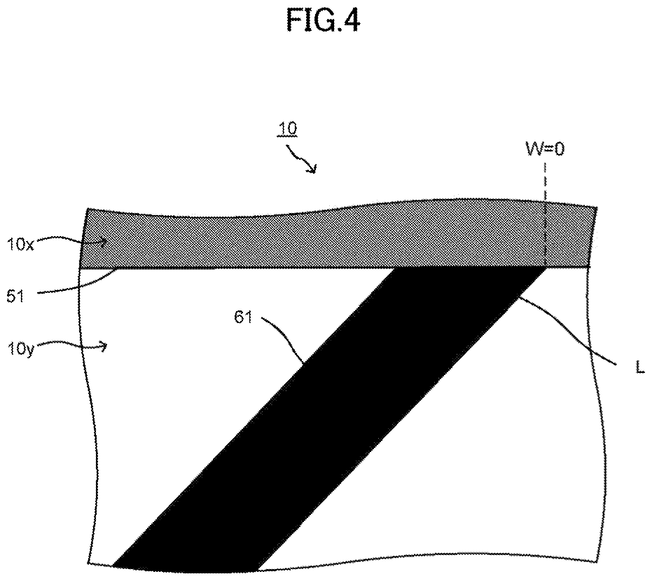

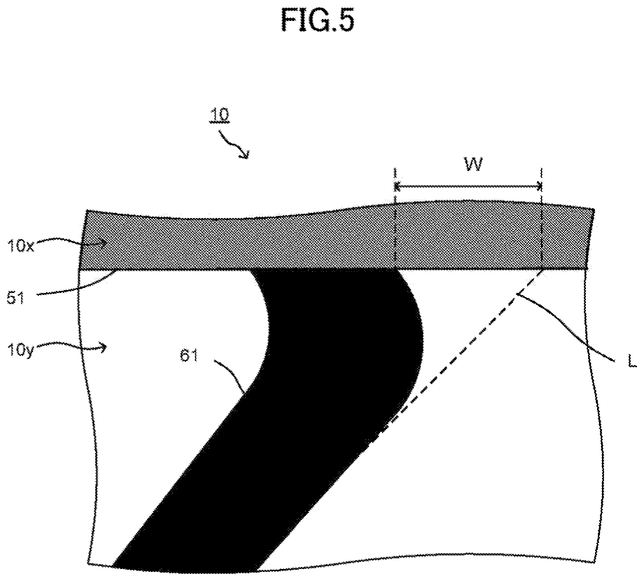

FIGS. 4 and 5 are enlarged views of an example of the zebra pattern 60 viewed from the vehicle interior-side of the laminated glass 10 in the vicinity of the boundary 51 between the transparent area 10y and the light shielding area 10x surrounded by the dotted line in the laminated glass 10 illustrated in FIG. 1. FIG. 4 is an example that shows no transparent warp, and FIG. 5 is an example that shows transparent warp. In FIG. 5, the black line 61 of the zebra pattern 60 appears to be curved and distorted near the boundary 51 between the transparent area 10y and the light shielding area 10x. For this reason, the distance between the position where the extension line L, which is the left side of the black line 61, intersects with the boundary 51 and the position where the black line 61 actually intersected with the boundary 51 was evaluated as warp (W) in accordance with the following criteria.

A: The warp (W) is less than 3 mm.
C: The warp (W) is 3 mm or more.

### <Heat Insulation>

The solar radiation reflectance Re of the laminated glass measured above was used for evaluation as an index of heat shielding property. All of the solar reflectance Re was all 20% or more, which was favorable.

### (Film Being Pulled Inward>

In the front view, a state of the outer periphery of the infrared reflective film being pulled inward from the position in the laminate before the pressure bonding was visually observed. The evaluation was performed according to the following criteria.

A: The infrared reflective film was not pulled inward.
B: A portion in which the outer periphery of the infrared reflective film was pulled inward over a length of 5 mm or more was recognized.

The value of the thermal contraction ratio (H) in the direction, in which the thermal contraction rate of the infrared reflective film being maximum divided by the average value of the thermal contraction rate in the direction in which the thermal contraction rate of the first adhesive layer and the second adhesive layer being maximum is calculated. The results are shown in Table 1.

| | Film properties of | | | Properties of | | Ratio | | | | | | | | | | |
|---|---|---|---|---|---|---|---|---|---|---|---|---|---|---|---|---|
| | Infrared reflective film | | | adhesive layer | | of | Properties of laminated glass | | | | | | | | | |
| | Thermal | | | Thermal | | ther- | | | | | Maxi- | | | | | |
| | contraction rate | | | contraction rate | | mal | | | Reflec- | | mum | Evaluation | | | | |
| | Direction | Ortho- | | Direction | Ortho- | con- | | | tive | | radius of | | | | | Film |
| Ex- | of maxi- | gonal | Thick- | of maxi- | gonal | trac- | | | color | | curva- | Or- | | Trans- | | being |
| am- | mum con- | direc- | ness | mum con- | direc- | tion | Rv | Re | (at 10° ) | | ture | ange | Wrink- | parent | Foam- | pulled |
| ples | traction | tion | [μm] | traction | tion | rate (H) | [%] | [%] | a* | b* | [mn] | peel | les | warp | ing | inward |
| 1 | 1.5% | 1.5% | 108 | 6.0% | 5.0% | 0.25 | 8.0 | 22.0 | 1.4 | −8.5 | 860 | A | A | A | A | A |
| 2 | 2.0% | 2.0% | 108 | 6.0% | 5.0% | 0.33 | 8.0 | 21.9 | 1.4 | −8.5 | 860 | A | A | A | A | A |
| 3 | 1.5% | 1.5% | 100 | 6.0% | 5.0% | 0.25 | 11.1 | 22.3 | 1.5 | −7.9 | 860 | B | A | A | A | A |
| 4 | 1.5% | 1.5% | 100 | 6.0% | 5.0% | 0.25 | 8.3 | 23.0 | 4.0 | 3.4 | 860 | B | A | A | A | A |
| 5 | 1.5% | 1.5% | 108 | 6.0% | 5.0% | 0.25 | 8.1 | 22.1 | 1.4 | −8.6 | 1050 | B | A | A | A | A |
| 6 | 1.5% | 1.5% | 108 | 8.5% | 7.0% | 0.18 | 8.0 | 22.0 | 1.4 | −8.5 | 860 | B | B | A | A | A |
| 7 | 2.0% | 2.0% | 108 | 3.0% | 2.0% | 0.67 | 8.1 | 22.0 | 1.4 | −8.5 | 860 | A | A | A | A | B |
| 8 | 1.2% | 1.2% | 108 | 6.0% | 5.0% | 0.2 | 8.1 | 22.7 | 1.4 | −8.6 | 860 | C | C | A | A | A |
| 9 | 2.4% | 2.4% | 108 | 6.0% | 5.0% | 0.4 | 7.9 | 23.1 | 1.5 | −8.6 | 860 | A | A | C | A | A |
| 10 | 1.5% | 1.5% | 75 | 6.0% | 5.0% | 0.25 | 8.0 | 21.6 | 1.4 | −8.5 | 860 | C | A | A | A | A |
| 11 | 1.5% | 1.5% | 130 | 6.0% | 5.0% | 0.25 | 8.0 | 21.9 | 1.5 | −8.5 | 860 | A | A | A | C | A |

### DESCRIPTION OF THE REFERENCE NUMERALS

10: Laminated glass (windshield)
1: First glass plate
2: Second glass plate
3: First adhesive layer
4: Second adhesive layer
5: Infrared reflective film
6: Black ceramic layer
10x: Light shielding area
10y: Transparent area

1. A vehicle windshield comprising:
a laminated glass in which a first glass plate, a first adhesive layer, an infrared reflective film, a second adhesive layer, and a second glass plate are laminated in this order,
wherein a total thickness of the first glass plate and the second glass plate is 4.1 mm or less,
the infrared reflective film contains a laminate in which 100 or more resin layers having different refractive indexes are laminated,
the infrared reflective film has thermal contraction rates, wherein a thermal contraction rate in the direction which the thermal contraction rate being maximum is 1.5% or more and 2.0% or less, and a thermal contraction rate in the direction orthogonal to the aforementioned direction is 1.5% or more and 2.0% or less, and the thermal contraction rates of the infrared reflective film in the predetermined directions being reduction rates of lengths in the predetermined directions before versus after maintaining the infrared reflective film at 150° C. for 30 minutes, and
a thickness of the infrared reflective film is 80 μm or more and 120 μm or less.

2. The vehicle windshield according to claim 1, wherein a visible light reflectance of the laminated glass measured from a vehicle exterior-side is 7% or more and 10% or less.

3. The vehicle windshield according to claim 1, wherein a color tone of the reflected light obtained by irradiating the laminated glass with light from a D65 light source from the vehicle exterior-side within an incident angle range of 10 to 60° in CIE1976L*a*b* chromaticity coordinates is −5<a*<3 and −12<b*<2.

4. The vehicle windshield according to claim 1, wherein a radius of curvature of the laminated glass is 900 mm or less in the test area A specified by JIS R3212 (1998) of the vehicle windshield.

5. The vehicle windshield according to claim 1, wherein the infrared reflective film is formed by alternately laminating two kinds of resin layers having different refractive indexes, and a resin forming the resin layers contains at least one kind selected from polyethylene terephthalate and polyethylene terephthalate copolymer.

6. The vehicle windshield according to claim 1,
wherein the first adhesive layer and the second adhesive layer have thermal contraction rates, wherein a thermal contraction rate in the direction which the thermal contraction rate being maximum is 2% or more and 8% or less, and a thermal contraction rate in the direction orthogonal to the aforementioned direction is 2% or more and 8% or less, and the thermal contraction rates of the first adhesive layer and the second adhesive layer in the predetermined directions being reduction rates of lengths in the predetermined directions before versus after maintaining the infrared reflective film at 50° C. for 10 minutes, and
a direction in which the thermal contraction rate of the infrared reflective film being maximum is orthogonal to a direction in which the thermal contraction rate of the first adhesive layer and the second adhesive layer being maximum.

7. The vehicle windshield according to claim 1, wherein the first adhesive layer and the second adhesive layer contain polyvinyl butyral.

8. The vehicle windshield according to claim 1, wherein the thermal contraction rate in the direction which the thermal contraction rate of the infrared reflective film being maximum divided by
an average value of thermal contraction rate in the direction which the thermal contraction rates of the first adhesive layer and the second adhesive layer being maximum is a value of 0.2 or more and 0.6 or less.

9. The vehicle windshield according to claim 1, wherein a black ceramic layer is provided on a main surface of the first glass plate and/or the second glass plate.

10. The vehicle windshield according to claim 9, wherein the black ceramic layer and the infrared reflective film have a portion overlapping in a plan view.
